(19) United States
(12) Patent Application Publication
(10) Pub. No.: US 2017/0211561 A1
(43) Pub. Date: Jul. 27, 2017

(54) VARIABLE DISPLACEMENT SWASH PLATE TYPE COMPRESSOR

(71) Applicant: KABUSHIKI KAISHA TOYOTA JIDOSHOKKI, Kariya-shi (JP)

(72) Inventors: Hiroyuki NAKAIMA, Kariya-shi (JP); Yuji HASHIMOTO, Kariya-shi (JP); Akihiro MURANISHI, Kariya-shi (JP)

(73) Assignee: KABUSHIKI KAISHA TOYOTA JIDOSHOKKI, Kariya-shi (JP)

(21) Appl. No.: 15/412,606

(22) Filed: Jan. 23, 2017

(30) Foreign Application Priority Data
Jan. 26, 2016 (JP) 2016-012459

(51) Int. Cl. F04B 27/18; F04B 27/10; B60H 1/32; F04B 27/08

(52) U.S. Cl. CPC F04B 27/18; F04B 27/0878; F04B 27/1054; B60H 1/3223; B60H 1/3216

(57) ABSTRACT

A variable displacement swash plate type compressor includes discharge passages through which refrigerant gas in a discharge passage is discharged. The discharge passages converge on downstream sides in the flowing direction of the refrigerant. A restrictor is provided in one of the discharge passages. The restrictor is used in the discharge passage to define first and second pressure monitoring points. Specifically, the first pressure monitoring point is located in the discharge passage on the upstream side of the restrictor in the flowing direction of refrigerant gas, and the second pressure monitoring point is located in the discharge passage on the downstream side of the restrictor.

### BACKGROUND OF THE INVENTION

The present invention relates to a variable displacement swash plate type compressor in the refrigerant circuit, for example, of a vehicle air conditioner and changes the pressure in a control pressure chamber to change the inclination angle of the swash plate, thereby changing the displacement.

A variable displacement swash plate type compressor includes a rotary shaft rotationally supported in the housing. The swash plate receives drive force from the rotary shaft to be rotated. Also, the variable displacement swash plate type compressor includes a bleed passage, which extends from the control pressure chamber to the suction pressure zone, and a supply passage, which extends from the discharge pressure zone to the control pressure chamber. The pressure (Pc) in the control pressure chamber is controlled by a control valve to change the inclination angle of the swash plate relative to a direction perpendicular to the rotation axis of the rotary shaft. Accordingly, the pistons engaged with the swash plate are reciprocated by a stroke according to the inclination angle of the swash plate, so that the displacement is changed.

In a vehicle having a variable displacement swash plate type compressor that uses the engine as the drive source, the compressor driving torque, which is required to drive the compressor, is estimated so that the engine output is controlled in a suitable manner. In general, the discharge flow rate is used as a parameter for estimating the compressor driving torque. In this regard, point-to-point differential pressure is detected between the pressure (PdH) at a first pressure monitoring point in the refrigerant circuit and the pressure (PdL) at a second pressure monitoring point, which is located downstream of the first pressure monitoring point in the flowing direction of refrigerant gas circulating in the refrigerant circuit. Japanese Laid-Open Patent Publication No. 2001-221158 discloses a control valve having a valve member that receives load based on the point-to-point differential pressure and is moved in the direction of the load to reduce the inclination angle of the swash plate.

The control valve includes a solenoid portion that is supplied with electricity to apply, to the valve member, an urging force that acts against the load acting on the valve member based on the point-to-point differential pressure, thereby controlling the opening degree of the valve member. The electricity supplied to the solenoid portion is controlled based on the difference between a set target room temperature and the detected actual room temperature. By controlling the supply of electricity to the solenoid portion, the opening degree of the valve member is controlled with the load applied to the valve member based on the point-to-point differential pressure in equilibrium with the urging force applied to the valve member by the solenoid member.

As the flow rate of the refrigerant gas flowing through the refrigerant circuit increases, the point-to-point differential pressure increases. In contrast, as the flow rate of the refrigerant gas flowing through the refrigerant circuit decreases, the point-to-point differential pressure decreases. Thus, the point-to-point differential pressure and the flow rate of the refrigerant gas flowing through the refrigerant circuit correlate with each other. Since the flow rate of the refrigerant gas flowing through the refrigerant circuit correlates with the displacement of the variable displacement swash plate type compressor, the displacement can be obtained by directly measuring the electricity supplied to the solenoid portion, which correlates with the displacement. Therefore, the compressor driving torque can be estimated using the displacement without providing, for example, a flow rate sensor that detects the flow rate of refrigerant gas.

In the graph of FIG. 6, the solid line is a characteristic line L10 that represents the relationship between point-to-point differential pressure and the flow rate of refrigerant gas. As shown in FIG. 6, in the region where the flow rate of the refrigerant gas is small, the point-to-point differential pressure between the first pressure monitoring point and the second pressure monitoring point tends to be small, and the fluctuation of the point-to-point differential pressure is small in relation to the fluctuation of the flow rate of the refrigerant gas. Thus, when the solenoid portion controls the opening degree of the valve member in the region of low flow rates of refrigerant gas, the urging force applied to the valve member by the solenoid portion needs to be finely changed. This makes it difficult to control the displacement of the variable displacement swash plate type compressor.

When the flow rate of refrigerant gas increases, and the load applied to the valve member based on the point-to-point differential pressure exceeds the urging force applied to the valve member by the solenoid portion at the time of maximum electricity supplied to the solenoid portion, the inclination angle of the swash plate decreases. This results in an undesirable reduction in the displacement of the variable displacement swash plate type compressor.

To cope with such a drawback, for example, the cross-sectional flow area of the restrictor between the first pressure monitoring point and the second pressure monitoring point may be increased. Compared to the case of the restrictor of the unchanged cross-sectional flow area (the characteristic line L10), the increase in the point-to-point differential pressure is small even if the flow rate of the refrigerant gas increases, as indicated by the characteristic line L11, which is the long dashed double-short dashed line in FIG. 6. Thus, the load applied to the valve member based on the point-to-point differential pressure is less likely to exceed the urging force applied to the valve member by the solenoid member at the time of the maximum electricity supplied to the solenoid portion. This allows the compressor to easily maintain the desirable displacement. However, if the cross-sectional flow area of the restrictor is increased, the point-to-point differential pressure will be further reduced between the first pressure monitoring point and the second pressure monitoring point, which degrades the controllability of the displacement of the variable displacement swash plate type compressor.

### SUMMARY OF THE INVENTION

Accordingly, it is an objective of the present invention to provide a variable displacement swash plate type compressor that improves the controllability of the displacement.

To achieve the foregoing objective and in accordance with one aspect of the present invention, a variable displacement swash plate type compressor that constitutes part of a refrigerant circuit is provided. The compressor includes a housing, a rotary shaft, a swash plate, pistons, and control valve. The housing includes a cylinder block, which includes a discharge chamber, a suction chamber, and a plurality of cylinder bores. The rotary shaft is rotationally supported by the housing. The swash plate is rotated by drive force from the rotary shaft and is tiltable relative to a direction perpendicular to a rotation axis of the rotary shaft. Each piston is reciprocally received in one of the cylinder bores. The control pressure chamber configured to change an inclination angle of the swash plate. The control valve configured to control pressure in the control pressure chamber. The control valve includes a valve member and a solenoid portion. A first pressure monitoring point is defined in the refrigerant circuit. A second pressure monitoring point is defined at a position on a downstream side of the first pressure monitoring point in a flowing direction of refrigerant that circulates through the refrigerant circuit. A point-to-point differential pressure is defined as a difference between a pressure at the first pressure monitoring point and a pressure at the second pressure monitoring point, which is lower than the pressure at the first pressure monitoring point. The valve member is configured such that, by receiving a load based on the point-to-point differential pressure, the valve member is moved in a direction of the load to reduce the inclination angle of the swash plate. The solenoid portion is configured such that, by being supplied with electricity, the solenoid portion applies, to the valve member, an urging force that acts against the load applied to the valve member based on the point-to-point differential pressure, thereby controlling an opening degree of the valve member. The control valve controls the pressure in the control pressure chamber to change the inclination angle of the swash plate, so that the pistons reciprocate by a stroke that corresponds to the inclination angle of the swash plate. The variable displacement swash plate type compressor further includes a plurality of discharge passages through which refrigerant in the discharge chamber is discharged, and a restrictor provided in one of the discharge passages. The discharge passages converge on downstream sides in the flowing direction of the refrigerant. The first pressure monitoring point is located in the discharge passage in which the restrictor is provided at a position on the upstream side of the restrictor in the flowing direction of the refrigerant. The second pressure monitoring point is located in the discharge passage in which the restrictor is provided at a position on the downstream side of the restrictor in the flowing direction of the refrigerant.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional side view illustrating a variable displacement swash plate type compressor according to one embodiment;

FIG. 2 is a cross-sectional view of the control valve when the swash plate is at the maximum inclination angle;

FIG. 3 is a cross-sectional view of the control valve when the swash plate is at the minimum inclination angle;

FIG. 4 is a cross-sectional side view of the variable displacement swash plate type compressor when the swash plate is at the minimum inclination angle;

FIG. 5 is a cross-sectional side view illustrating a variable displacement swash plate type compressor according to another embodiment; and

FIG. 6 is a graph showing the relationship between point-to-point differential pressure and the flow rate of refrigerant gas in a conventional variable displacement swash plate type compressor.

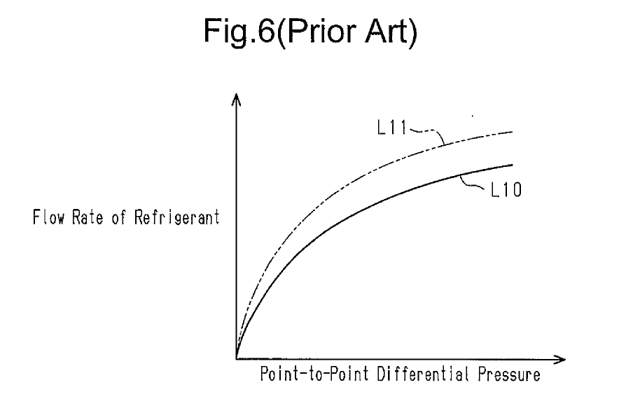

### DETAILED DESCRIPTION OF THE PREFERRED EMBODIMENTS

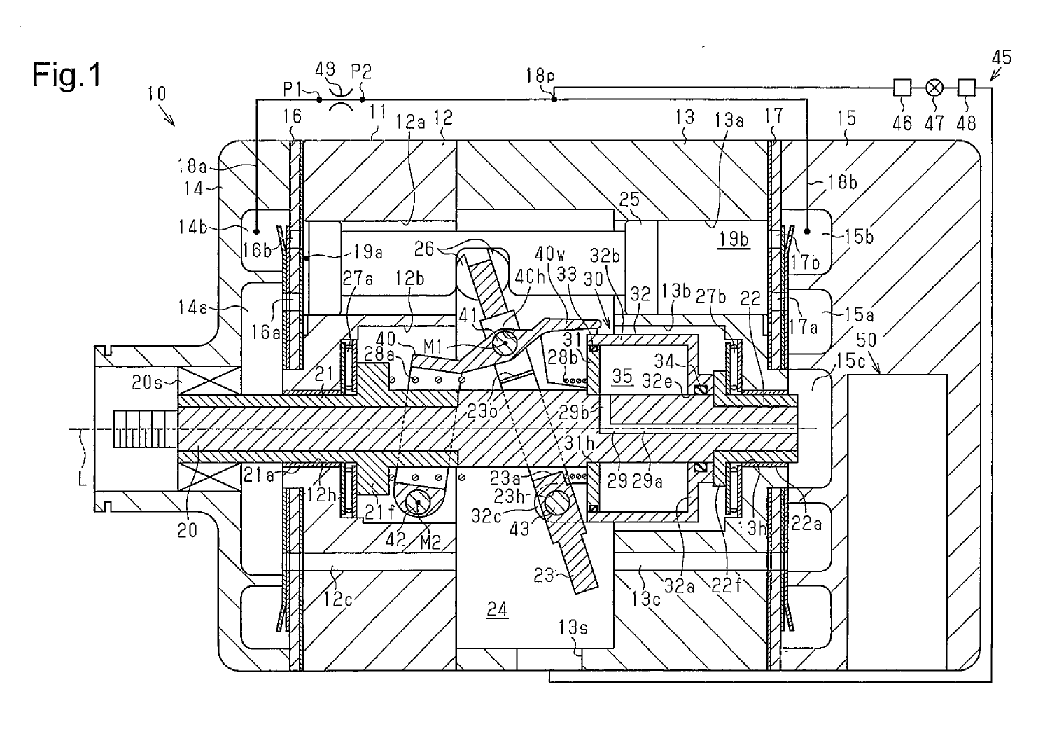

A variable displacement swash plate type compressor according to one embodiment will now be described with reference to FIGS. 1 to 4. The variable displacement swash plate type compressor of the present embodiment is mounted on a vehicle and employed for a vehicle air conditioner.

As shown in FIG. 1, the variable displacement swash plate type compressor 10 has a housing 11, which includes a first cylinder block 12 and a second cylinder block 13, which are coupled to each other to make a pair. The first cylinder block 12 and the second cylinder block 13 are both cylindrical.

The housing 11 further includes a front housing member 14 coupled to the first cylinder block 12 and a rear housing member 15 coupled to the second cylinder block 13. The front and rear housing members 14, 15 are each formed into a cylindrical shape having a closed end. A first valve-port assembly plate 16 is arranged between the front housing member 14 and the first cylinder block 12. Further, a second valve-port assembly plate 17 is arranged between the rear housing member 15 and the second cylinder block 13.

A first suction chamber 14a and a first discharge chamber 14b are defined between the front housing member 14 and the first valve-port assembly plate 16. The first discharge chamber 14b is located radially outward of the first suction chamber 14a. Likewise, a second suction chamber 15a and a second discharge chamber 15b are defined between the rear housing member 15 and the second valve-port assembly plate 17. Additionally, a pressure adjusting chamber 15c is arranged in the rear housing member 15. The pressure adjusting chamber 15c is located at the center of the rear housing member 15, and the second suction chamber 15a is located radially outward of the pressure adjusting chamber 15c. The second discharge chamber 15b is located radially outward of the second suction chamber 15a. The first and second discharge chambers 14b, 15b each constitute a discharge pressure zone.

The first valve-port assembly plate 16 has suction ports 16a, which communicate with the first suction chamber 14a, and discharge ports 16b, which communicate with the first discharge chamber 14b. The second valve-port assembly plate 17 has suction ports 17a, which communicate with the second suction chamber 15a, and discharge ports 17b, which communicate with the second discharge chamber 15b.

A rotary shaft 20 is rotationally supported in the housing 11. A cylindrical first supporting member 21 is press-fitted to the outer circumferential surface of one end of the rotary shaft 20. A cylindrical second supporting member 22 is press-fitted to the outer circumferential surface of the other end of the rotary shaft 20. The first and second supporting members 21, 22 constitute parts of the rotary shaft 20. The first supporting member 21 extends through a shaft hole 12h in the first cylinder block 12. The second supporting member 22 extends through a shaft hole 13h in the second cylinder block 13. One end of the second supporting member 22 is located in the pressure adjusting chamber 15c.

A first plain bearing 21a is arranged between the first supporting member 21 and the shaft hole 12h. A second plain bearing 22a is arranged between the second supporting member 22 and the shaft hole 13h. The first supporting member 21 is rotationally supported by the first cylinder block 12 via the first plain bearing 21a. The second supporting member 22 is rotationally supported by the second cylinder block 13 via the second plain bearing 22a.

A sealing device 20s of a lip seal type is located between the front housing member 14 and the rotary shaft 20. One end of the rotary shaft 20 is connected to an external drive source, which is a vehicle engine in this embodiment, through a power transmission mechanism (not shown). In the present embodiment, the power transmission mechanism is a clutchless mechanism, which constantly transmits power. The power transmission mechanism is, for example, a combination of a belt and pulleys.

The housing 11 includes a swash plate chamber 24 defined by the first cylinder block 12 and the second cylinder block 13. The swash plate chamber 24 accommodates a swash plate 23, which is rotated by drive force from the rotary shaft 20 and is tiltable with respect to a direction (the vertical direction as viewed in FIG. 1) that is perpendicular to the rotational axis L of the rotary shaft 20. The swash plate 23 has an insertion hole 23a, through which the rotary shaft 20 extends. The swash plate 23 is assembled to the rotary shaft 20 by inserting the rotary shaft 20 into the insertion hole 23a.

The first cylinder block 12 has first cylinder bores 12a (only one of the first cylinder bores 12a is illustrated in FIG. 1), which extend along the axis of the first cylinder block 12 and are arranged about the rotary shaft 20. Each first cylinder bore 12a is connected to the first suction chamber 14a via the corresponding suction port 16a and is connected to the first discharge chamber 14b via the corresponding discharge port 16b.

The second cylinder block 13 has second cylinder bores 13a (only one of the second cylinder bores 13a is illustrated in FIG. 1), which extend along the axis of the second cylinder block 13 and are arranged about the rotary shaft 20. Each second cylinder bore 13a is connected to the second suction chamber 15a via the corresponding suction port 17a and is connected to the second discharge chamber 15b via the corresponding discharge port 17b.

The first cylinder bores 12a and the second cylinder bores 13a are arranged to make front-rear pairs. Each pair of the first cylinder bore 12a and the second cylinder bore 13a accommodates a double-headed piston 25, while permitting the piston 25 to reciprocate in the front-rear direction. The variable displacement swash plate type compressor 10 of the present embodiment is a double-headed piston swash plate type compressor.

Each double-headed piston 25 is engaged with the peripheral portion of the swash plate 23 with a pair of shoes 26. The shoes 26 convert rotation of the swash plate 23, which rotates with the rotary shaft 20, to linear reciprocation of the double-headed pistons 25. Thus, the pairs of the shoes 26 function as a conversion mechanism that reciprocates the double-headed pistons 25 in the pairs of the first cylinder bores 12a and the second cylinder bores 13a as the swash plate 23 rotates.

In each first cylinder bore 12a, a first compression chamber 19a is defined by the double-headed piston 25 and the first valve-port assembly plate 16. In each second cylinder bore 13a, a second compression chamber 19b is defined by the double-headed piston 25 and the second valve-port assembly plate 17.

The first cylinder block 12 has a first large diameter hole 12b, which is continuous with the shaft hole 12h and has a larger diameter than the shaft hole 12h. The first large diameter hole 12b communicates with the swash plate chamber 24 and constitutes a part of the swash plate chamber 24. The swash plate chamber 24 and the first suction chamber 14a are connected to each other by a suction passage 12c, which extends through the first cylinder block 12 and the first valve-port assembly plate 16.

The second cylinder block 13 has a second large diameter hole 13b, which is continuous with the shaft hole 13h and has a larger diameter than the shaft hole 13h. The second large diameter hole 13b communicates with the swash plate chamber 24 and constitutes a part of the swash plate chamber 24. The swash plate chamber 24 and the second suction chamber 15a are connected to each other by a suction passage 13c, which extends through the second cylinder block 13 and the second valve-port assembly plate 17.

The first supporting member 21 has an annular first flange 21f, which is arranged in the first large diameter hole 12b. With respect to the axial direction of the rotary shaft 20, a first thrust bearing 27a is arranged between the first flange 21f and the first cylinder block 12. The second supporting member 22 has an annular second flange 22f, which is arranged in the second large diameter hole 13b. With respect to the axial direction of the rotary shaft 20, a second thrust bearing 27b is arranged between the second flange 22f and the second cylinder block 13.

The swash plate chamber 24 accommodates an actuator 30. The actuator 30 changes the inclination angle of the swash plate 23 with respect to a direction that is perpendicular to the rotational axis L of the rotary shaft 20. The actuator 30 is arranged between the second flange 22f and the swash plate 23. The actuator 30 includes an annular partition body 31, which rotates integrally with the rotary shaft 20. The partition body 31 has an insertion hole 31h, into which the rotary shaft 20 is inserted. The partition body 31 is integrated with the rotary shaft 20 by inserting and press-fitting and fixing the rotary shaft 20 in the insertion hole 31h.

The actuator 30 also has a cylindrical movable body 32, which has a closed end and is located between the second flange 22f and the partition body 31. The movable body 32 is movable along the axis of the rotary shaft 20 in the swash plate chamber 24. The movable body 32 is arranged to be allowed to enter the second large diameter hole 13b. The movable body 32 includes an annular bottom portion 32a and a cylindrical portion 32b. The bottom portion 32a has a through-hole 32e, through which the rotary shaft 20 extends. The cylindrical portion 32b extends along the axis of the rotary shaft 20 from the outer periphery of the bottom portion 32a. The movable body 32 rotates integrally with the rotary shaft 20. The clearance between the inner circumferential surface of the cylindrical portion 32b and the outer circumferential surface of the partition body 31 is sealed by a sealing member 33. Likewise, the clearance between the through-hole 32e and the rotary shaft 20 is sealed by a sealing member 34. The actuator 30 has a control pressure chamber 35 defined by the partition body 31 and the movable body 32.

A restoration spring 28a is fixed to the first supporting member 21. The restoration spring 28a extends from the first supporting member 21 toward the swash plate chamber 24. Also, an inclination reducing spring 28b is provided between the partition body 31 and the swash plate 23. One end of the inclination reducing spring 28b is fixed to the partition body 31, and the other end is fixed to the swash plate 23. The inclination reducing spring 28b urges the swash plate 23 in a direction to reduce the inclination angle of the swash plate 23.

The rotary shaft 20 has an in-shaft passage 29, which connects the control pressure chamber 35 and the pressure adjusting chamber 15c to each other. The in-shaft passage 29 is constituted by a first in-shaft passage 29a, which extends along the axis of the rotary shaft 20, and a second in-shaft passage 29b, which communicates with the first in-shaft passage 29a and extends in the radial direction of the rotary shaft 20. The rear end of the first in-shaft passage 29a communicates with the pressure adjusting chamber 15c. One end of the second in-shaft passage 29b communicates with the distal end of the first in-shaft passage 29a. The other end of the second in-shaft passage 29b opens to the control pressure chamber 35. Thus, the control pressure chamber 35 and the pressure adjusting chamber 15c are connected to each other by the first in-shaft passage 29a and the second in-shaft passage 29b.

In the swash plate chamber 24, a lug arm 40 is provided between the swash plate 23 and the first flange 21f. The lug arm 40 has a substantially L shape extending from one end to the other. A weight portion 40w is provided at one end of the lug arm 40. The weight portion 40w is passed through a slot 23b of the swash plate 23 to be located at a position behind the swash plate 23.

The lug arm 40 has an insertion hole 40h at one end to receive a columnar first pin 41, which extends through the slot 23b. By inserting the first pin 41 through the insertion hole 40h, one end of the lug arm 40 is coupled to the upper end of the swash plate 23 (the upper end as viewed in FIG. 1). In this configuration, one end of the lug arm 40 is supported by the swash plate 23 such that the lug arm 40 is allowed to swing about a first swing axis M1, which is the axis of the first pin 41. The other end of the lug arm 40 is coupled to a coupling portion (not shown) of the first supporting member 21 by a columnar second pin 42. In this configuration, the second end of the lug arm 40 is supported by the first supporting member 21 such that the lug arm 40 is allowed to swing about a second swing axis M2, which is the axis of the second pin 42. In the present embodiment, the lug arm 40, the first pin 41, and the second pin 42 constitute a link mechanism that allows the inclination angle of the swash plate 23 to be changed.

A coupling portion 32c is provided at the distal end of the cylindrical portion 32b of the movable body 32. The coupling portion 32c protrudes toward the swash plate 23. A columnar coupling pin 43 is press-fitted and fixed to the coupling portion 32c. The swash plate 23 has an insertion hole 23h, which is outside of the insertion hole 23a (below the insertion hole 23a as viewed in FIG. 1) and receives the coupling pin 43. The coupling pin 43 couples the coupling portion 32c to the lower end of the swash plate 23. When the rotary shaft 20 rotates, the swash plate 23 rotates together with the actuator 30 and the lug arm 40.

The variable displacement swash plate type compressor 10 includes a first discharge passage 18a, into which refrigerant gas is discharged from the first discharge chamber 14b, and a second discharge passage 18b, into which refrigerant is discharged from the second discharge chamber 15b. The downstream ends in the flowing direction of refrigerant gas of the discharge passages 18a, 18b converge. A suction inlet 13s is provided in the peripheral wall of the second cylinder block 13. The suction inlet 13s, and a confluent portion 18p of the discharge passages 18a, 18b are connected to each other by an external refrigerant circuit 45.

The external refrigerant circuit 45 includes a condenser 46, which is connected to the confluent portion 18p, an expansion valve 47, which connected to the condenser 46, and an evaporator 48, which is connected to the expansion valve 47. The evaporator 48 is connected to the suction inlet 13s. The variable displacement swash plate type compressor 10 constitutes part of the refrigerant circuit (the cooling circuit) of the vehicle air conditioner.

After being drawn into the swash plate chamber 24 via the suction inlet 13s, refrigerant gas is drawn into the first and second suction chambers 14a, 15a via the suction passages 12c, 13c. The first and second suction chambers 14a, 15a and the swash plate chamber 24 are therefore in a suction pressure zone and exposed to substantially the same pressure.

A restrictor 49 is provided in the first discharge passage 18a. The refrigerant circuit has a first pressure monitoring point P1 on the upstream side of the restrictor 49 in the flowing direction of refrigerant gas and a second pressure monitoring point P2 on the downstream side of the restrictor 49. Thus, in the present embodiment, the restrictor 49 is used in the first discharge passage 18a to define the first and second pressure monitoring points P1, P2. Specifically, the first pressure monitoring point P1 is located in the first discharge passage 18a on the upstream side of the restrictor 49 in the flowing direction of refrigerant gas, and the second pressure monitoring point P2 is located in the first discharge passage 18a on the downstream side of the restrictor 49. The pressure (PdH) at the first pressure monitoring point P1 is higher than the pressure (PdL) at the second pressure monitoring point P2.

An electromagnetic control valve 50 for controlling the pressure in the control pressure chamber 35 is installed in the rear housing member 15. The control valve 50 is electrically connected to a control computer (not shown). The control computer is connected to an air conditioner switch (not shown) to transmit signals.

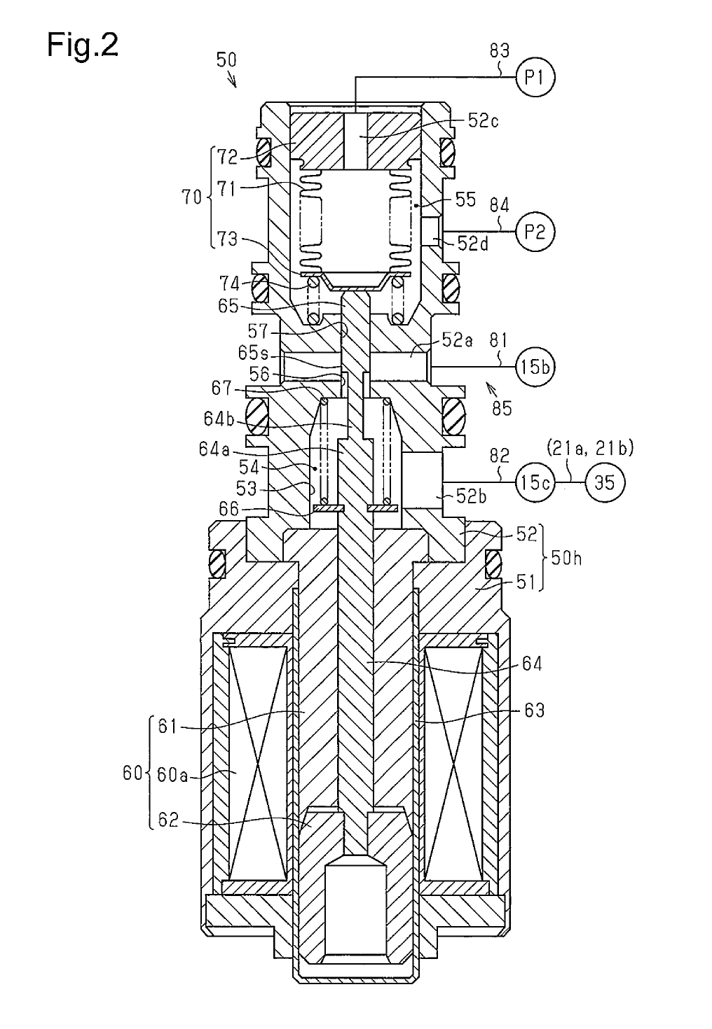

As shown in FIG. 2, a valve housing 50h of the control valve 50 includes a cylindrical first housing member 51, which accommodates a solenoid portion 60, and a cylindrical second housing member 52, which is installed in the first housing member 51. The solenoid portion 60 includes a cylindrical fixed iron core 61, a coil 60a, and a movable iron core 62, which is attracted to the fixed iron core 61 when electricity is supplied to the coil 60a. The electromagnetic force of the solenoid portion 60 attracts the movable iron core 62 toward the fixed iron core 61. The solenoid portion 60 is subjected to current control (duty cycle control) performed by the control computer.

The fixed iron core 61 is arranged at the opening of the first housing member 51 that corresponds to the second housing member 52 and is partly located in the second housing member 52. The movable iron core 62 is arranged at a position in the first housing member 51 that is opposite to the second housing member 52. The fixed iron core 61 and the movable iron core 62 are accommodated in a cylindrical case 63 having a closed end. The movable iron core 62 is fixed to a pillar-shaped drive force transmitting body 64. The drive force transmitting body 64 extends into the second housing member 52 from the movable iron core 62 through the fixed iron core 61.

The second housing member 52 has a recess 53 at the end that faces the first housing member 51. The recess 53 and the fixed iron core 61 define an accommodation chamber 54. The second housing member 52 has a pressure sensing chamber 55 at a position on the side opposite to the first housing member 51. A valve hole 56 is provided in the bottom of the recess 53 to communicate with the accommodation chamber 54. The second housing member 52 has a first port 52a, which extends in a direction perpendicular to the axis of the drive force transmitting body 64 and communicates with the valve hole 56. The second housing member 52 has a through-hole 57, which is continuous with the first port 52a and the pressure sensing chamber 55. The diameter of the valve hole 56 is equal to that of the through-hole 57. The drive force transmitting body 64 extends through the accommodation chamber 54, the valve hole 56, and the through-hole 57 and protrudes into the pressure sensing chamber 55.

The drive force transmitting body 64 has a large diameter portion 64a, a small diameter portion 64b, and a valve member 65. The large diameter portion 64a extends from the movable iron core 62 and through the fixed iron core 61, and projects into the accommodation chamber 54. The small diameter portion 64b is continuous with the large diameter portion 64a and has a diameter smaller than that of the large diameter portion 64a. The small diameter portion 64b extends through the valve hole 56. The valve member 65 is continuous with the small diameter portion 64b and has a diameter greater than that of the small diameter portion 64b. The valve member 65 extends through the through-hole 57 and protrudes into the pressure sensing chamber 55. Thus, in the present embodiment, the valve member 65 is part of and integrated with the drive force transmitting body 64. The outer circumferential surface of the valve member 65 slides on the inner circumferential surface of the through-hole 57 and seals the clearance between the first port 52a and the pressure sensing chamber 55. The section of the outer circumferential surface of the valve member 65 closer to the valve hole 56 serves as a peripheral sealing member 65s, which enters the valve hole 56 to close the valve hole 56.

A stopper ring 66 is attached to the outer surface of the large diameter portion 64a at a position in the accommodation chamber 54. A spring 67 is provided between the stopper ring 66 and the bottom of the recess 53. The spring 67 urges the drive force transmitting body 64 toward the solenoid portion 60. The spring 67 thus urges the movable iron core 62 away from the fixed iron core 61. The electromagnetic force of the solenoid portion 60 acts against the force of the spring 67 and attracts the movable iron core 62 toward the fixed iron core 61.

The pressure sensing chamber 55 accommodates a pressure sensing mechanism 70. The pressure sensing mechanism 70 includes a copper bellows 71, a cylindrical support 72, and a pressure receiving body 73. The bellows 71 can extend and contract in the direction in which the drive force transmitting body 64 is moved. The support 72 is coupled to one end of the bellows 71. The pressure receiving body 73 is coupled to the other end of the bellows 71. The distal end of the valve member 65 contacts the pressure receiving body 73. The pressure sensing chamber 55 accommodates a spring 74 that urges the pressure receiving body 73 toward the support 72.

The valve hole 56 communicates with the second discharge chamber 15b via the first port 52a and a first passage 81. The second housing member 52 has a second port 52b, which communicates with the accommodation chamber 54. The accommodation chamber 54 communicates with the pressure adjusting chamber 15c via the second port 52b and a second passage 82. The first passage 81, the first port 52a, the valve hole 56, the accommodation chamber 54, the second port 52b, the second passage 82, the pressure adjusting chamber 15c, and the in-shaft passage 29 form a supply passage 85 extending from the second discharge chamber 15b to the control pressure chamber 35.

The support 72 has a third port 52c, which communicates with the interior of the bellows 71. The interior of the bellows 71 communicates with the first pressure monitoring point P1 via the third port 52c and a third passage 83. The second housing member 52 has a fourth port 52d, which communicates with the pressure sensing chamber 55. The pressure sensing chamber 55 communicates with the second pressure monitoring point P2 via the fourth port 52d and a fourth passage 84. The pressure sensing mechanism 70 is displaced in accordance with the point-to-point differential pressure, which is the difference between the pressure (PdH) at the first pressure monitoring point P1 and the pressure (PdL) at the second pressure monitoring point P2. The displacement of the pressure sensing mechanism 70 controls the pressure (Pc) in the control pressure chamber 35 such that the displacement is changed to cancel the fluctuation of the point-to-point differential pressure. The valve member 65 receives the load toward the solenoid portion 60 based on the point-to-point differential pressure. The load based on the point-to-point differential pressure moves the valve member 65 toward the solenoid portion 60. When in the valve hole 56, the valve member 65 closes the supply passage 85. When out of the valve hole 56, the valve member 65 opens the supply passage 85.

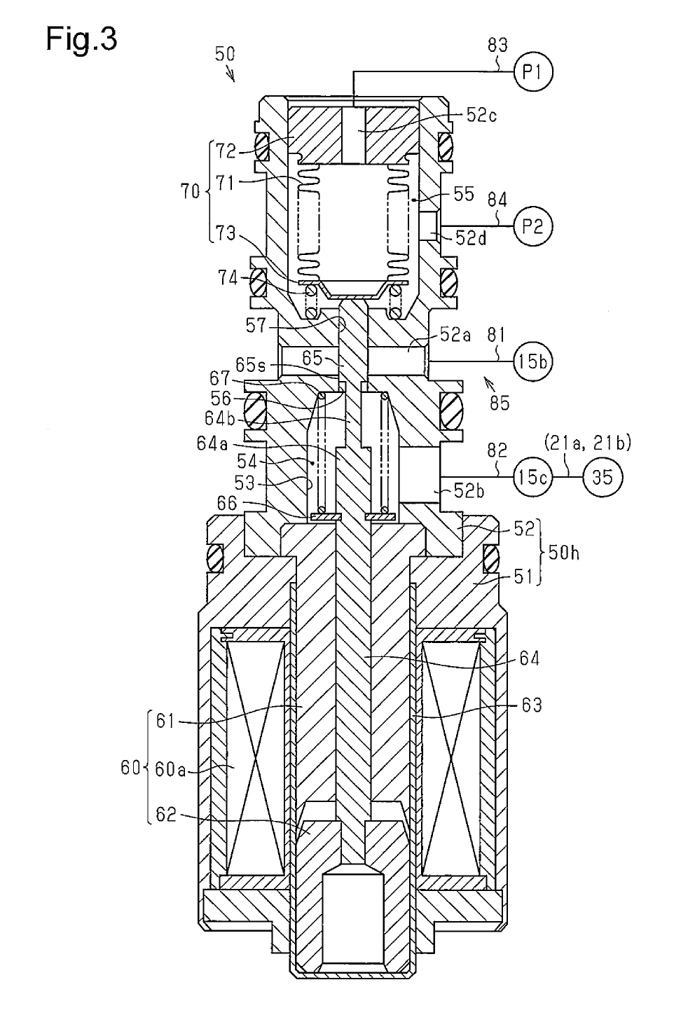

When the air conditioner switch is turned off and the supply of electricity to the solenoid portion 60 is stopped in the variable displacement swash plate type compressor 10, the movable iron core 62 is separated from the fixed iron core 61 by the force of the spring 67 as shown in FIG. 3. The valve member 65 receives the load based on the point-to-point differential pressure and is moved toward the solenoid portion 60. This causes the valve member 65 to enter and close the valve hole 56. When the valve member 65 closes the valve hole 56, the supply of refrigerant gas is stopped from the second discharge chamber 15b to the control pressure chamber 35 via the first passage 81, the first port 52a, the valve hole 56, the accommodation chamber 54, the second port 52b, the second passage 82, the pressure adjusting chamber 15c, and the in-shaft passage 29. Then, refrigerant gas is discharged from the control pressure chamber 35 to the second suction chamber 15a through the bleed passage (not shown), so that the pressure in the control pressure chamber 35 approaches the pressure in the second suction chamber 15a.

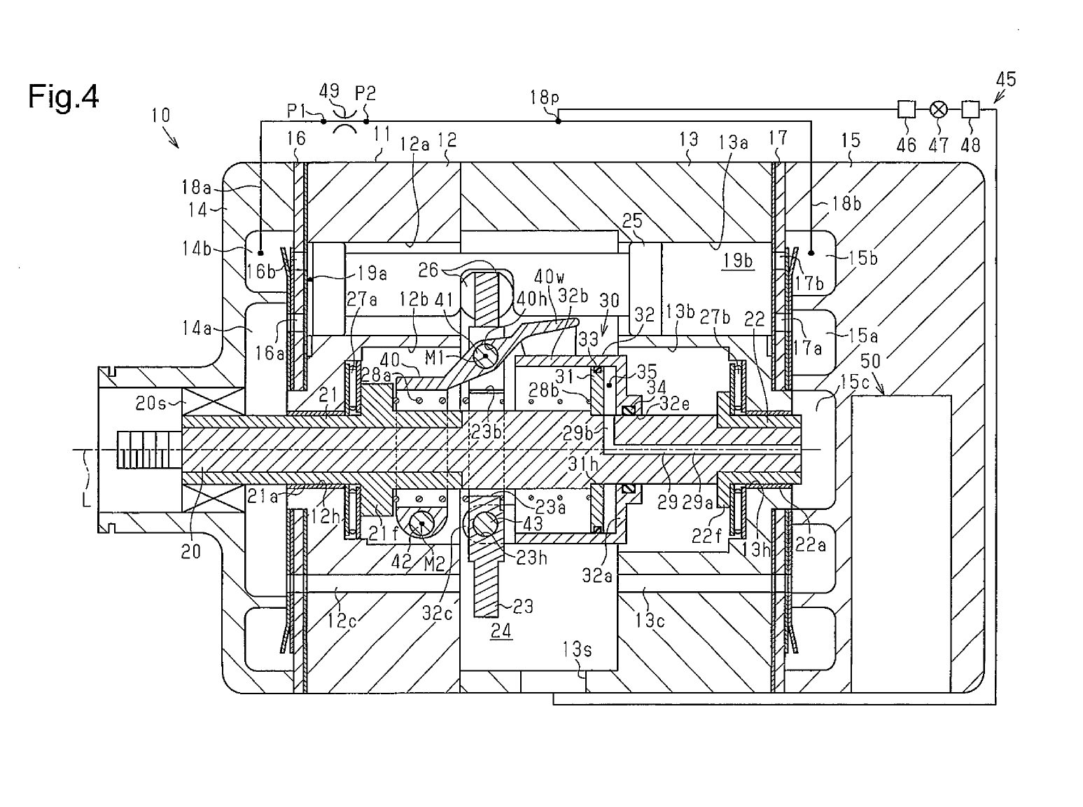

When the pressure in the control pressure chamber 35 approaches the pressure in the second suction chamber 15a to reduce the pressure difference between the control pressure chamber 35 and the swash plate chamber 24, the compression reaction force applied to the swash plate 23 by the double-headed piston 25 causes the swash plate 23 to pull the movable body 32 via the coupling pin 43. This moves the movable body 32 such that the bottom portion 32a approaches the partition body 31 as shown in FIG. 4. When the movable body 32 moves such that the bottom portion 32a approaches the partition body 31, the swash plate 23 swings about the first swing axis M1. As the swash plate 23 swings about the first swing axis M1, the lug arm 40 swings about the second swing axis M2 to approach the first flange 21f. Accordingly, the inclination angle of the swash plate 23 is reduced so that the swash plate 23 contacts the restoration spring 28a. When the inclination angle of the swash plate 23 is reduced, the stroke of the double-headed pistons 25 is reduced. Accordingly, the displacement is decreased. Thus, the valve member 65 receives the load based on the point-to-point differential pressure to move in the direction of the load and reduces the inclination angle of the swash plate 23.

In the variable displacement swash plate type compressor 10 of the present embodiment, each pair of the first cylinder bore 12a and the second cylinder bore 13a reciprocally accommodates a double-headed piston 25. In this configuration, as the inclination angle of the swash plate 23 decreases, the dead volume of the second compression chamber 19b (the clearance between the double-headed piston 25 at the top dead center and the second valve-port assembly plate 17) is increased. In contrast, the discharge stroke is performed without a significant increase in the dead volume (the clearance between the double-headed piston 25 at the top dead center and the first valve-port assembly plate 16) in the first compression chamber 19a. Thus, the lug arm 40 is arranged such that, as the inclination angle of the swash plate 23 is changed, the top dead center position of the double-headed piston 25 in each second compression chamber 19b is displaced by a greater amount than the top dead center position of the piston 25 in the corresponding first compression chamber 19a.

When the dead volume of the second compression chamber 19b becomes a predetermined volume as the inclination angle of the swash plate 23 is reduced to a predetermined inclination angle, refrigerant gas stops being discharged from the second compression chamber 19b. Thus, in the process in which the inclination angle of the swash plate 23 decreases from the predetermined inclination angle to the minimum inclination angle, the pressure in the second compression chamber 19b does not reach the discharge pressure. Therefore, discharge and suction of refrigerant gas are not performed, and only compression and expansion of refrigerant gas are repeated. In the region where the flow rate of the refrigerant gas is small, only the refrigerant gas that has been compressed in the first compression chambers 19a is discharged.

When the air conditioner switch is turned on and the supply of electricity to the solenoid portion 60 is started, the electromagnetic force of the solenoid portion 60 act against the force of the spring 67 and attracts the movable iron core 62 toward the fixed iron core 61 as shown in FIG. 2. The control computer controls the electricity supplied to the solenoid portion 60 based on the difference between the set target room temperature and the detected actual room temperature.

The opening degree of the valve member 65 is adjusted by the equilibrium between the degree by which the movable iron core 62 is attached to the fixed iron core 61 and the load applied to the valve member 65 based on the point-to-point differential pressure. When the electricity supplied to the solenoid portion 60 is increased (when the duty cycle is increased), the degree of attraction of the movable iron core 62 toward the fixed iron core 61 is increased. Accordingly, the solenoid portion 60 applies, to the valve member 65, urging force that acts against the load applied to the valve member 65 based on the point-to-point differential pressure. This causes the valve member 65 to project from the valve hole 56, so that the opening degree of the valve member 65 is increased.

Increase in the opening degree of the valve member 65 increases the flow rate of refrigerant gas that is supplied to the control pressure chamber 35 from the second discharge chamber 15b via the first passage 81, the first port 52a, the valve hole 56, the accommodation chamber 54, the second port 52b, the second passage 82, the pressure adjusting chamber 15c, and the in-shaft passage 29, so that the pressure in the control pressure chamber 35 approaches the pressure in the second discharge chamber 15b.

When the pressure in the control pressure chamber 35 approaches the pressure in the second discharge chamber 15b, and the pressure difference between the control pressure chamber 35 and the swash plate chamber 24 increases, the movable body 32 is moved such that the bottom portion 32a is separated from the partition body 31, while pulling the swash plate 23 via the coupling pin 43, as shown in FIG. 1. When the bottom portion 32a of the movable body 32 is moved away from the partition body 31, the swash plate 23 is swung about the first swing axis M1 in a direction opposite to the swinging direction to decrease the inclination angle of the swash plate 23. As the swash plate 23 swings about the first swing axis M1 in a direction opposite to the inclination angle decreasing direction, the lug arm 40 swings about the second swing axis M2 in a direction opposite to the swinging direction to decrease the inclination angle of the swash plate 23. This moves the lug arm 40 away from the first flange 21f. This increases the inclination angle of the swash plate 23 and thus increases the stroke of the double-headed pistons 25. Accordingly, the displacement is increased.

Therefore, in the present embodiment, the control valve 50 is arranged on the supply passage 85. The so-called inlet-side control is performed, in which the opening degree of the control valve 50 is adjusted to control the amount of refrigerant gas supplied from the discharge pressure zone to the control pressure chamber 35 via the supply passage 85, thereby controlling the pressure in the control pressure chamber 35.

Operation of the present embodiment will now be described.

In the present embodiment, the restrictor 49 is used in the first discharge passage 18a to define the first and second pressure monitoring points P1, P2. Specifically, the first pressure monitoring point P1 is located in the first discharge passage 18a on the upstream side of the restrictor 49 in the flowing direction of refrigerant gas, and the second pressure monitoring point P2 is located in the first discharge passage 18a on the downstream side of the restrictor 49.

For example, in some refrigerant circuits, a restrictor is arranged at a position downstream in the flowing direction of refrigerant gas from the confluent portion of the discharge passages 18a, 18b, and first and second pressure monitoring points are set, accordingly. In this case, the flow rates of refrigerant gas flowing through the first pressure monitoring point and the second pressure monitoring point are greater than the flow rates of refrigerant gas flowing through the first pressure monitoring point P1 and the second pressure monitoring point P2 in the above illustrated embodiment. Even if the cross-sectional flow area of the restrictor 49 is reduced, the load applied to the valve member 65 based on the point-to-point differential pressure is unlikely to exceed the urging force applied to the valve member 65 by the solenoid portion 60 at the time of the maximum electricity supplied to the solenoid portion 60.

Since the cross-sectional flow area of the restrictor 49 is reduced, the differential pressure between the first pressure monitoring point P1 and the second pressure monitoring point P2 is easily increased in the region of low flow rates of refrigerant gas, so that the fluctuation of the point-to-point differential pressure is increased in relation to the fluctuation of the flow rate of refrigerant gas. Thus, when the opening degree of the valve member 65 is controlled by the solenoid portion 60 in the region of low flow rate of refrigerant gas, the urging force applied to the valve member 65 by the solenoid portion 60 is easily adjusted.

The above described embodiment achieves the following advantages.

(1) The variable displacement swash plate type compressor 10 has the discharge passages 18a, 18b, which discharge the refrigerant gas in the first and second discharge chambers 14b, 15b, respectively. The downstream ends in the flowing direction of refrigerant gas of the discharge passages 18a, 18b converge, and the restrictor 49 is provided in the first discharge passage 18a. The restrictor 49 is used in the first discharge passage 18a to define the first and second pressure monitoring points P1, P2.

Specifically, the first pressure monitoring point P1 is located in the first discharge passage 18a on the upstream side of the restrictor 49 in the flowing direction of refrigerant gas, and the second pressure monitoring point P2 is located in the first discharge passage 18a on the downstream side of the restrictor 49. This reduces the flow rates of refrigerant that passes through the first pressure monitoring point P1 and the second pressure monitoring point P2, for example, compared to the flow rates of refrigerant that passes through first and second pressure monitoring points in a case in which a restrictor is arranged at a position downstream in the flowing direction of refrigerant gas from the confluent portion of the discharge passages 18a, 18b, and the first and second pressure monitoring points are set accordingly. Even if the cross-sectional flow area of the restrictor 49 is reduced, the load applied to the valve member 65 based on the point-to-point differential pressure is unlikely to exceed the urging force applied to the valve member 65 by the solenoid portion 60 at the time of the maximum electricity supplied to the solenoid portion 60. This allows the variable displacement swash plate type compressor 10 to easily maintain the desirable displacement.

Since the cross-sectional flow area of the restrictor 49 is reduced, the differential pressure between the first pressure monitoring point P1 and the second pressure monitoring point P2 is easily increased in the region of low flow rates of refrigerant gas, so that the fluctuation of the point-to-point differential pressure is increased in relation to the fluctuation of the flow rate of refrigerant gas. Thus, when the opening degree of the valve member 65 is controlled by the solenoid portion 60 in the region of low flow rate of refrigerant gas, the urging force applied to the valve member 65 by the solenoid portion 60 is easily adjusted. This facilitates the control of the displacement of the variable displacement swash plate type compressor 10 and thus improves the controllability of the displacement.

(2) The above described present embodiment improves the controllability of the displacement of the variable displacement swash plate type compressor 10, which a double-headed piston 25 is reciprocally accommodated in each pair of the first cylinder bore 12a and the second cylinder bore 13a.

(3) When the inclination angle of the swash plate 23 is reduced, the dead volume increases in each second compression chamber 19b. When the dead volume of the second compression chamber 19b reaches a predetermined volume, the discharge stroke of the double-headed pistons 25 in the second compression chambers 19b is stopped. Thus, in the region where the flow rate of the refrigerant gas is small, only the refrigerant gas that has been compressed in the first compression chambers 19a is discharged. In the present embodiment, the restrictor 49 is used in the first discharge passage 18a to define the first and second pressure monitoring points P1, P2.

Specifically, the first pressure monitoring point P1 is located in the first discharge passage 18a on the upstream side of the restrictor 49 in the flowing direction of refrigerant gas, and the second pressure monitoring point P2 is located on the downstream side of the restrictor 49. Thus, when the opening degree of the valve member 65 is controlled by the solenoid portion 60 in the region of low flow rate of refrigerant gas, the urging force applied to the valve member 65 by the solenoid portion 60 is easily adjusted. This facilitates the control of the displacement of the variable displacement swash plate type compressor 10, which includes a link mechanism that is arranged such that, as the inclination angle of the swash plate 23 is changed, the top dead center position of the double-headed piston 25 in each second compression chamber 19b is displaced by a greater amount than the top dead center position of the piston 25 in the corresponding first compression chamber 19a.

The above illustrated embodiment may be modified as follows.

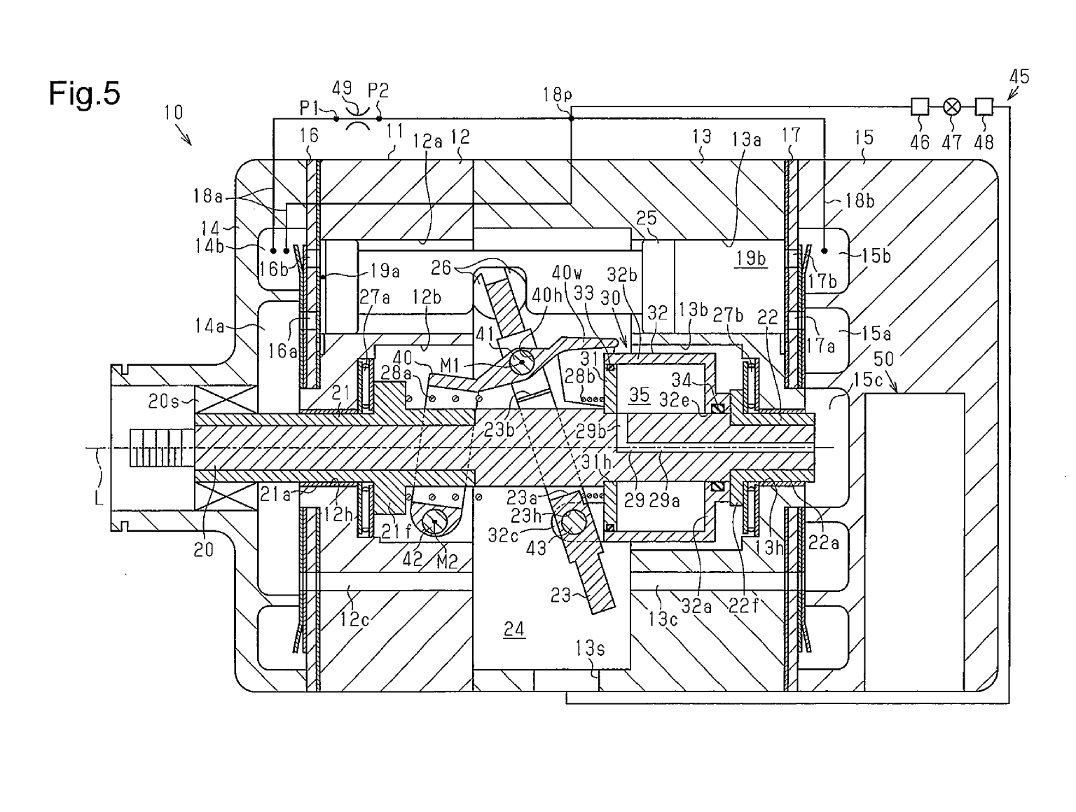

As shown in FIG. 5, the variable displacement swash plate type compressor 10 may include a plurality of discharge passages 18a (two in the embodiment of FIG. 5). In the embodiment shown in FIG. 5, a restrictor 49 is provided in one of the two first discharge passages 18a. In this case, the flow rates of refrigerant gas flowing through the first pressure monitoring point P1 and the second pressure monitoring point P2 are lower than the flow rates of refrigerant gas flowing through the first pressure monitoring point P1 and the second pressure monitoring point P2 in the case in which only one first discharge passage 18a is provided. Thus, even if the cross-sectional flow area of the restrictor 49 is reduced, the load applied to the valve member 65 based on the point-to-point differential pressure is unlikely to exceed the urging force applied to the valve member 65 by the solenoid portion 60 at the time of the maximum electricity supplied to the solenoid portion 60 compared to a case in which one first discharge passage 18a is provided. This allows the variable displacement swash plate type compressor 10 to more easily maintain the desirable displacement.

In the embodiment shown in FIG. 5, a restrictor 49 may be provided in each of the two first discharge passages 18a. In this case, the restrictor 49 provided in one of the two first discharge passages 18a is used to define the first and second pressure monitoring points P1, P2. Specifically, the first pressure monitoring point P1 is located in the first discharge passage 18a on the upstream side of the restrictor 49 in the flowing direction of refrigerant gas, and the second pressure monitoring point P2 is located in the first discharge passage 18a on the downstream side of the restrictor 49.

In the above illustrated embodiment, a restrictor 49 may also be arranged in the discharge passage 18b. However, even in this case, the restrictor 49 is preferably used in the first discharge passage 18a to define the first and second pressure monitoring points P1, P2. Specifically, the first pressure monitoring point P1 is preferably located in the first discharge passage 18a on the upstream side of the restrictor 49 in the flowing direction of refrigerant gas, and the second pressure monitoring point P2 is preferably located in the first discharge passage 18a on the downstream side of the restrictor 49.

In the above illustrated embodiment, the variable displacement swash plate type compressor 10 may include a link mechanism that is arranged such that, as the inclination angle of the swash plate 23 is changed, the top dead center position of the double-headed piston 25 in each first compression chamber 19a and the top dead center position of the double-headed piston 25 in the corresponding second compression chamber 19b are displaced in similar manners. In this case, for example, the restrictor 49 may be provided in the second discharge passage 18b instead of the first discharge passage 18a. Alternatively, the restrictor 49 may be provided in each of the two first discharge passages 18a. In this case, the restrictor 49 provided in one of the first and second discharge passages 18a, 18b is used to define the first and second pressure monitoring points P1, P2. Specifically, the first pressure monitoring point P1 is located in one of the discharge passages 18a, 18b on the upstream side of the restrictor 49 in the flowing direction of refrigerant gas, and the second pressure monitoring point P2 is located in the discharge passage 18a, 18b on the downstream side of the restrictor 49.

In the above illustrated embodiment, the numbers of the discharge passages 18a, 18b are not particularly limited. That is, two or more discharge passages 18a and two or more discharge passages 18b may be provided.

In the above illustrated embodiment, the valve member 65 may, for example, include an end face sealing portion that contacts the periphery of the valve hole 56 in the second housing member 52 to close the valve hole 56.

In the above illustrated embodiment, the valve member 65 may be a member independent of the drive force transmitting body 64 as long as the valve member 65 and the drive force transmitting body 64 are moved integrally.

In the above illustrated embodiment, the variable displacement swash plate type compressor 10 may be configured to perform so called outlet-side control, in which a control valve is provided in the bleed passage, and the opening degree of the control valve is adjusted to control the amount of refrigerant gas discharged to the suction pressure zone from the control pressure chamber via the bleed passage, thereby controlling the pressure in the control pressure chamber 35.

In the above illustrated embodiment, the variable displacement swash plate type compressor 10 may be configured to include a three-way valve as the control valve, which is capable of performing both of the inlet-side control and the outlet-side control.

In the above illustrated embodiment, the actuator 30 may be configured such that, when the pressure in the control pressure chamber 35 is lowered, the movable body 32 is moved to increase the inclination angle of the swash plate 23, and that the inclination angle of the swash plate 23 is maximized when the pressure in the control pressure chamber 35 is substantially equal to the pressure in the second suction chamber 15a. Also, the actuator 30 may be configured such that, when the pressure in the control pressure chamber 35 is increased, the movable body 32 is moved to decrease the inclination angle of the swash plate 23, and that the inclination angle of the swash plate 23 is minimized when the pressure in the control pressure chamber 35 is substantially equal to the pressure in the discharge chamber 15b. That is, the actuator 30 may be configured to decrease the pressure in the control pressure chamber 35 to increase the displacement.

In the illustrated embodiment, the variable displacement swash plate type compressor 10 is a double-headed piston swash plate type compressor having the double-headed pistons 25, but may be a single-headed piston swash plate type compressor having single-headed pistons. Also, the variable displacement swash plate type compressor 10 may be configured to control the pressure in the swash plate chamber 24 by using the control valve 50 to change inclination angle of the swash plate 23. In this case, the swash plate chamber 24 functions as a control pressure chamber for changing the inclination angle of the swash plate 23.

In the above illustrated embodiment, the lug arm 40 may be arranged such that, as the inclination angle of the swash plate 23 is changed, the top dead center position of the double-headed piston 25 in each first compression chamber 19a is displaced by a greater amount than the top dead center position of the piston 25 in the corresponding second compression chamber 19b. In this case, as the inclination angle of the swash plate 23 decreases, the dead volume in each first compression chamber 19a is increased. In contrast, in each second compression chamber 19b, the discharge stroke is performed without any significant increase in the dead volume.

In the above illustrated embodiment, one end of the rotary shaft 20 may be coupled to an external drive source, which is a vehicle engine, via a clutch mechanism that is caused to selectively transmit and disconnect power through external electric control.

In the illustrated embodiment, the variable displacement swash plate type compressor 10 may be used in any type of air conditioner instead of a vehicle air conditioner.

Therefore, the present examples and embodiments are to be considered as illustrative and not restrictive and the invention is not to be limited to the details given herein, but may be modified within the scope and equivalence of the appended claims.

1. A variable displacement swash plate type compressor that constitutes part of a refrigerant circuit, the compressor comprising:
a housing including a cylinder block, which includes a discharge chamber, a suction chamber, and a plurality of cylinder bores;
a rotary shaft that is rotationally supported by the housing;
a swash plate that is rotated by drive force from the rotary shaft and is tiltable relative to a direction perpendicular to a rotation axis of the rotary shaft;
pistons, each of which is reciprocally received in one of the cylinder bores;
a control pressure chamber configured to change an inclination angle of the swash plate; and
a control valve configured to control pressure in the control pressure chamber, wherein
the control valve includes a valve member and a solenoid portion,
a first pressure monitoring point is defined in the refrigerant circuit,
a second pressure monitoring point is defined at a position on a downstream side of the first pressure monitoring point in a flowing direction of refrigerant that circulates through the refrigerant circuit,
a point-to-point differential pressure is defined as a difference between a pressure at the first pressure monitoring point and a pressure at the second pressure monitoring point, which is lower than the pressure at the first pressure monitoring point,
the valve member is configured such that, by receiving a load based on the point-to-point differential pressure, the valve member is moved in a direction of the load to reduce the inclination angle of the swash plate,
the solenoid portion is configured such that, by being supplied with electricity, the solenoid portion applies, to the valve member, an urging force that acts against the load applied to the valve member based on the point-to-point differential pressure, thereby controlling an opening degree of the valve member,
the control valve controls the pressure in the control pressure chamber to change the inclination angle of the swash plate, so that the pistons reciprocate by a stroke that corresponds to the inclination angle of the swash plate,
the variable displacement swash plate type compressor further includes
a plurality of discharge passages through which refrigerant in the discharge chamber is discharged, and
a restrictor provided in one of the discharge passages,
the discharge passages converge on downstream sides in the flowing direction of the refrigerant,
the first pressure monitoring point is located in the discharge passage in which the restrictor is provided at a position on the upstream side of the restrictor in the flowing direction of the refrigerant, and
the second pressure monitoring point is located in the discharge passage in which the restrictor is provided at a position on the downstream side of the restrictor in the flowing direction of the refrigerant.

2. The variable displacement swash plate type compressor according to claim 1, wherein
the cylinder block is one of first and second cylinder blocks of the housing,
the first cylinder block includes first cylinder bores,
the second cylinder block includes second cylinder bores, each of which constitutes a pair with one of the first cylinder bores,
the pistons are double-headed pistons,
the first and second cylinder bores reciprocally accommodate the double-headed pistons,
the double-headed piston accommodated in each first cylinder bore defines a first compression chamber in the first cylinder bore,
the double-headed piston accommodated in each second cylinder bore defines a second compression chamber in the second cylinder bore,
the discharge chamber is a first compression chamber into which refrigerant that has been compressed in the first compression chambers is discharged,
the housing further includes a second discharge chamber into which refrigerant that has been compressed in the second compression chambers is discharged,
the discharge passages include
at least one first discharge passage into which the refrigerant in the first discharge chamber is discharged, and
at least one second discharge passage into which the refrigerant in the second discharge chamber is discharged,
the first and second discharge passages converge on downstream sides in the flowing direction of the refrigerant,
the restrictor is provided in one of the first and second discharge passages,
the first pressure monitoring point is located in the first or second discharge passage in which the restrictor is provided at a position on the upstream side of the restrictor in the flowing direction of the refrigerant, and
the second pressure monitoring point is located in the first or second discharge passage in which the restrictor is provided at a position on the downstream side of the restrictor in the flowing direction of the refrigerant.

3. The variable displacement swash plate type compressor according to claim 2, further comprising a link mechanism arranged between the rotary shaft and the swash plate, wherein
the link mechanism allows change of the inclination angle of the swash plate relative to the direction perpendicular to the rotation axis of the rotary shaft,
the link mechanism is arranged such that, as the inclination angle of the swash plate is changed, a top dead center position of the double-headed piston in each second compression chamber is displaced by a greater amount than a top dead center position of the double-headed piston in the corresponding first compression chamber,
the restrictor is provided in the first discharge passage,
the first pressure monitoring point is located in the first discharge passage at a position on the upstream side of the restrictor in the flowing direction of the refrigerant, and
the second pressure monitoring point is located in the first discharge passage at a position on the downstream side of the restrictor in the flowing direction of the refrigerant.

4. The variable displacement swash plate type compressor according to claim 3, the at least one first discharge passage is one of a plurality of first discharge passages.
